(19) United States
(12) Patent Application Publication
(10) Pub. No.: US 2011/0265389 A1
(43) Pub. Date: Nov. 3, 2011

(54) System and Method for Securing a Door Assembly to a Structure

(75) Inventor: Stefan Pfleger, Amarillo, TX (US)

(73) Assignee: ZARGES ALUMINUM SYSTEMS LLC, Amarillo, TX (US)

(21) Appl. No.: 12/772,956

(22) Filed: May 3, 2010

(51) Int. Cl. E06B 7/16

(52) U.S. Cl. 49/493.1; 49/506

(57) ABSTRACT

A system and method for sealing a door assembly to a structure is disclosed. Specifically, a sealing system is disclosed, having a press frame, the press frame having a first side and a second side. The first side is capable of connecting to a doorframe, and the second side comprises an indention. The sealing system also comprises a weatherproof material having a first portion within the indention, and a second portion extending outside of the indention.

### BACKGROUND

This disclosure relates to a system and method for sealing a door assembly to a structure. More particularly, this disclosure relates to sealing the space between a doorframe and a structure frame using an improved press frame.

Sometimes a metal structure, such as a wind turbine, requires a door to be placed on the structure. Various methods exist to secure a doorframe. In one embodiment, the door assembly is welded to the structure. However, such process requires a welder, and makes the door difficult to remove. In another embodiment, the door is fastened using a steel plate system. However such system is also difficult to install and uninstall. Additionally, in such cases the material used to create the door assembly and the material to create the structure can be different. Changes in temperature can cause the different materials to expand and contract at different rates, thereby compromising the seal between the door assembly and the metal structure. It would therefore be advantageous to implement an improved method and system for sealing a door assembly to a structure.

### SUMMARY

A system for sealing a door assembly to a structure is disclosed. Specifically, a sealing system is disclosed, having a press frame, the press frame having a first side a second side. The first side is capable of connecting to a doorframe, and the second side comprises an indention. The sealing system also comprises a weatherproof material having a first portion within the indention, and a second portion extending outside of the indention.

Further, a method of sealing a space between a door assembly and a structure frame is disclosed. The method comprises pressing a door assembly against a structure frame, wherein the door assembly comprises a doorframe, a press frame and a weatherproof material. The press frame has a first side and a second side, wherein the first side is connected to the doorframe, and the second side faces the structure frame and comprises an indention. The weatherproof material has a first portion within the indention, and a second portion extending outside of the indention until such pressing against the structure frame deforms said weatherproof material.

Further, a door assembly comprising a doorframe, a press frame and a weatherproof material is disclosed. The press frame has a first side and a second side, wherein the first side is connected to the doorframe, and the second side comprises an indention. The weatherproof material has a first portion within the indention, and a second portion extending outside of the indention.

### BRIEF DESCRIPTION OF THE DRAWINGS

FIG. 1A illustrates a wind turbine comprising a structure frame.

FIG. 1B illustrates an expanded view of a tower base.

FIG. 2A illustrates a front view of door assembly.

FIG. 2B illustrates a rear view of a door assembly.

FIG. 3 illustrates a rear view of a door assembly mounted to a structure frame.

FIG. 4 illustrates a cross section of a frame bracket securing a press frame to a structure frame.

### DETAILED DESCRIPTION

Described herein is a system and method for sealing a door assembly to a structure. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

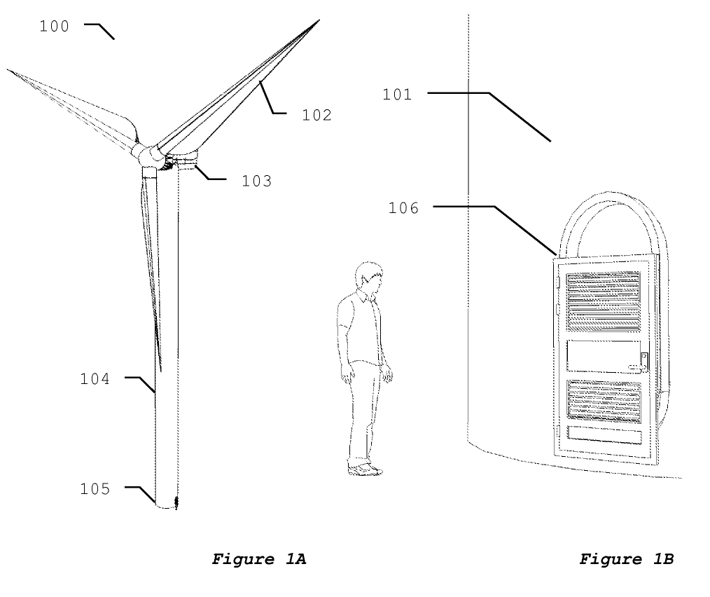

FIG. 1A illustrates a wind turbine 100 comprising a structure frame 101. Within this disclosure, a wind turbine 100 is discussed. However such discussion is merely exemplary of an apparatus with a structure frame 101, and is not intended to limit the scope of the invention to use with a wind turbine 100. Wind turbine 100 can comprise blades 102, a turbine 103 and a tower 104 that can extend downward from turbine 103 to a foundation 105. FIG. 1B illustrates an expanded view of tower 104. Tower 104 can comprise a structure frame 101. A door assembly 106 can mount to structure frame 101.

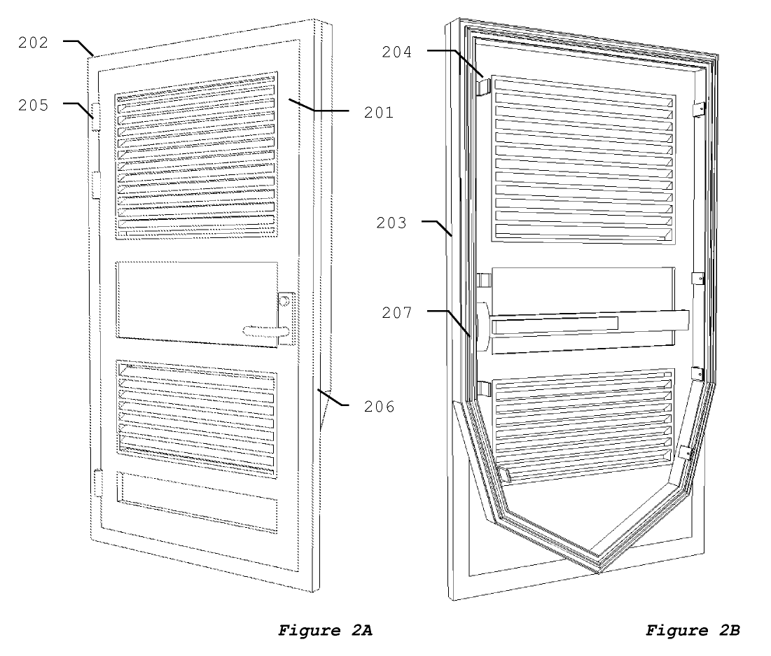

FIG. 2A illustrates a front view of door assembly 106. FIG. 2B illustrates a rear view of door assembly 106. Door assembly 106 can comprise a door 201, a doorframe 202, a press frame 203, and/or press frame brackets 204. In one embodiment, door assembly 106 can also comprise hinges 205. In such embodiment, doorframe 202 can circumscribe door 201. Hinges 205 can connect door 201 to doorframe 202 along one edge of door 201, allowing door 201 to open and close. Press frame 203 can have a press frame first side 206 that can connect to doorframe 202. Press frame 203 can also have a press frame second side 207 that can face structure frame 101. In one embodiment, press frame 203 can be substantially the same shape as doorframe 202. In another embodiment, press frame 203 can be substantially the same shape as structure frame 101. In another embodiment, press frame 203 can be substantially the same shape as an innermost shape created by overlapping doorframe 202 with structure frame 101 (for example, a convex lens shape being the innermost shape created by overlapping two circles). In another embodiment, press frame 203 is not closed form. Each press frame bracket 204 can protrude out from press frame 203. In one embodiment, each frame bracket protrudes away from press frame 203 substantially parallel to the plane of door 201 before bending to become substantially orthogonal to the plane of door 201. In such embodiment, a press frame bracket first end 206 can be against or within press frame 203, and a press frame bracket second end 207 can be substantially orthogonal to the plane of door 201.

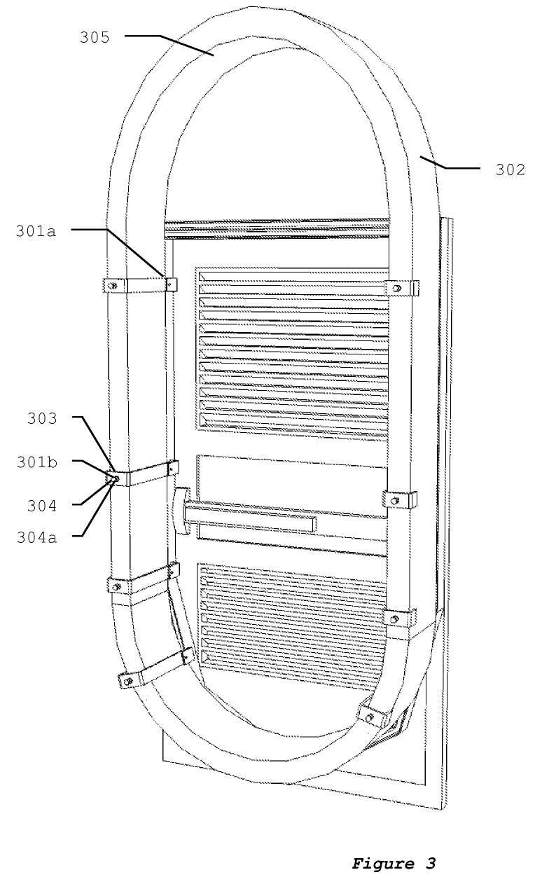

FIG. 3 illustrates a rear view of door assembly 106 mounted to structure frame 101. To mount door assembly 106 to structure frame 101, a structure frame bracket 401 can connect to each press frame bracket 204 using a first fastener 301a. Examples of a fastener 301 can include any suitable fastener 301 known in the art, and includes, but is not limited to nuts, bolds and rivets. Structure frame bracket 401 can extend from the connection point with press frame bracket 204, in a direction substantially parallel with a structure frame inner surface 305 and in a direction away from door 201. Upon reaching the edge of structure frame 101, frame bracket can bend around structure frame 101, maintaining it's substantial parallel relationship with structure frame 101. In one embodiment, after bending around structure frame 101, structure frame bracket 401 can bend once more to become parallel with an outer surface of structure frame 101. An orifice 303 can exist in structure frame bracket 401 that allows a tension device 304 to be placed within press frame bracket 204, tension device 304 extending in a direction substantially orthogonal to the plane of door 201, and towards press frame 203.

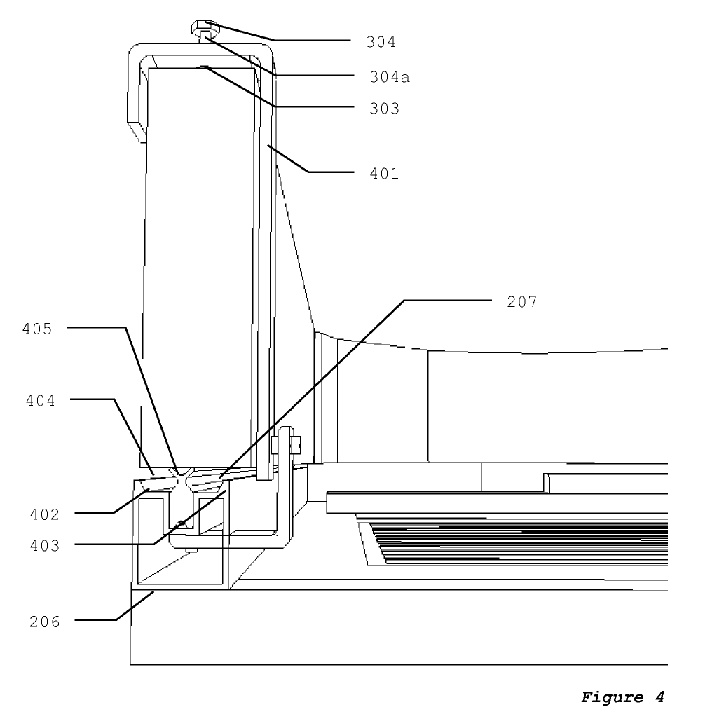

FIG. 4 illustrates a cross section of a structure frame bracket 401 securing a press frame 203 to a structure frame 101. In one embodiment, orifice 303 is threaded, and tension device 304 is a threaded fastener 304a. In another embodiment, a threaded fastener receiver is placed securely within orifice 303, and tension device 304 is threaded fastener 304a. In another embodiment, threaded fastener receiver is larger than orifice 303, and is placed between structure frame bracket 401 and structure frame 101. Threaded fastener 304a extends through orifice 303 and then through threaded fastener receiver to structure frame 101. In this embodiment, threaded fastener receiver 305 can be a nut, and is well known in the art. Further in one embodiment, threaded fastener 304a is blunted on an end making contact with structure frame 101.

A second fastener 301b can connect press frame bracket first end 206 to press frame 203. In each embodiment involving threaded fastener 304a, threaded fastener 304a can be screwed into threading device. As threaded fastener 304a makes contact with structure frame 101, the screwing motion pushes structure frame bracket 401 in a direction orthogonal to the plane of door 201 and away from structure frame 101. Such motion can cause tension between structure frame bracket 401 and press frame bracket 204, pulling press frame 203 towards structure frame 101 until press frame 203 presses against structure frame 101.

In one embodiment, press frame 203 can be improved to provide an improved seal between press frame 203 and structure frame 101. In one embodiment, press frame 203 forms an outer ridge 402 and an inner ridge 403. Between outer ridge 402 and inner ridge 403 can exist an indention 404. Indention 404 can be house a weather resistant material 405. An example of weather resistant material 405 is silicone. Such example is exemplary and not limiting. In one embodiment weather resistant material 405 can be in the form of a rectangular with a circular segment removed from each side, when in its non-deformed state. A first portion of weather resistant material 405 can be bent downward and placed within indention 404. A second portion of weather resistant material 405 can protrude upwards from rectangular empty space, out past outer ridge 402 and inner ridge 403, such that when press frame 203 is placed towards structure frame 101, weather resistant material 405 touches structure frame 101 before press frame 203 makes contact with structure frame 101. As press frame 203 is forced up against structure frame 101, weather resistant material 405 can further deform, while remaining pressed against structure frame 101, thereby creating a barrier.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A doorframe sealing system comprising:
a press frame, the press frame having a first side and a second side, wherein
the first side is capable of connecting to a doorframe, and
the second side comprises an indention; and
a weatherproof material having a first portion within the indention, and a second portion extending outside of the indention.

2. The system of claim 2, wherein the indention forms an outer ridge.

3. The system of claim 3, wherein the indention forms an inner ridge.

4. The system of claim 2 wherein the indention forms an inner ridge.

5. The system of claim 2 wherein the weatherproof material is silicone.

6. The system of claim 5 wherein the first portion of the silicone is in a deformed state within the indention.

7. The system of claim 6 wherein a cross section of the silicone forms a rectangle with an arc segment removed from each of two opposite sides, when in a non-deformed position.

8. The system of claim 2 wherein the press frame is aluminum.

9. A method of sealing a space between a door assembly and a structure frame, comprising
Pressing a door assembly against a structure frame, wherein the door assembly comprises
a doorframe;
a press frame having a first side and a second side, wherein the first side is connected to the doorframe, and the second side faces the structure frame and comprises an indention; and
a weatherproof material having a first portion within the indention, and a second portion extending outside of the indention until such pressing against the structure frame deforms said weatherproof material.

10. The method of claim 9 wherein the indention forms an outer ridge and inner ridge

11. The method of claim 10 wherein the assembly is pressed until the outer ridge and inner ridge make contact with the structure frame.

12. The method of claim 9 wherein the weatherproof material is silicone.

13. The method of claim 9 including the step of rotating a threaded fastener to cause the door assembly to press against the structure frame.

14. A door assembly comprising
a doorframe;
a press frame having a first side and a second side, wherein the first side is connected to the doorframe, and the second side comprises an indention; and
a weatherproof material having a first portion within the indention, and a second portion extending outside of the indention.

15. The door assembly of claim 14, wherein the press frame is substantially the same shape as the doorframe.

16. The doorframe assembly of claim 14, wherein the press frame is substantially the same shape as the structure frame.

17. The doorframe assembly of claim 14, wherein the press frame is substantially the same shape as an innermost shape created by overlapping the doorframe with the structure frame.
